(19) United States
(12) Patent Application Publication
(10) Pub. No.: US 2016/0275572 A1
(43) Pub. Date: Sep. 22, 2016

(54) INFORMATION PROCESSING APPARATUS, INFORMATION PROCESSING METHOD, AND NON-TRANSITORY COMPUTER READABLE STORAGE MEDIUM

(71) Applicant: YAHOO JAPAN CORPORATION, Tokyo (JP)

(72) Inventors: Kazuki OMACHI, Tokyo (JP); Yohei SENO, Tokyo (JP)

(73) Assignee: YAHOO JAPAN CORPORATION, Tokyo (JP)

(21) Appl. No.: 15/015,545

(22) Filed: Feb. 4, 2016

(30) Foreign Application Priority Data
Mar. 20, 2015 (JP) 2015-057830

(51) Int. Cl. G06Q 30/02

(52) U.S. Cl. CPC G06Q 30/0277; G06Q 30/0256

(57) ABSTRACT

An information processing apparatus according to an embodiment includes an accepting unit and a distributing unit. The accepting unit accepts a request for a web page from a terminal device. The distributing unit distributes a web page including an advertisement area with a size equal to or smaller than a predetermined ratio of a display screen size of the terminal device. Thus, the information processing apparatus can prevent a reduction in the click rate for advertisement information.

### CROSS-REFERENCE TO RELATED APPLICATION

The present application claims priority to and incorporates by reference the entire contents of Japanese Patent Application No. 2015-057830 filed in Japan on Mar. 20, 2015.

### BACKGROUND OF THE INVENTION

1. Field of the Invention

The present invention relates to an information processing apparatus, an information processing method, and a non-transitory computer readable storage medium having stored therein an information processing program.

2. Description of the Related Art

An enormous amount of information is disclosed on the Internet, and users often use search sites to search for information that the users want to know. In the search sites, advertisement distribution called search matching advertising or search advertising are sometimes performed.

For example, Japanese Patent No. 3676999 discloses a technique, in which when listing information (a search results list) is displayed, advertisement information related to the listing information is selected from among pieces of advertisement information prepared in advance, and the selected advertisement information is displayed in a predetermined area provided for the advertisement information.

However, in the above-described conventional technique, it is not always possible to prevent a reduction in the click rate for the advertisement information. Specifically, the above-described conventional technique is to only provide a user with a search results page including advertisement information corresponding to a search keyword specified by the user, and is not always able to prevent a reduction in the click rate for the advertisement information.

### SUMMARY OF THE INVENTION

It is an object of the present invention to at least partially solve the problems in the conventional technology.

According to one aspect of an embodiment, An information processing apparatus includes an accepting unit that accepts a request for a web page from a terminal device and a distributing unit that distributes a web page including an advertisement area with a size equal to or smaller than a predetermined ratio of a display screen size of the terminal device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to a first embodiment;

FIG. 2 is a diagram illustrating a configuration example of an information processing system according to the first embodiment;

FIG. 3 is a diagram illustrating a configuration example of an information processing apparatus according to the first embodiment;

FIG. 4 is a diagram illustrating an example of an advertisement information storage unit according to the first embodiment;

FIG. 5 is a diagram illustrating an example of a terminal information storage unit according to the first embodiment;

FIG. 6 is a flowchart illustrating the flow of information processing performed by the information processing system according to the first embodiment;

FIG. 7 is a diagram illustrating a configuration of an information processing apparatus according to a second embodiment;

FIG. 8 is a diagram illustrating an example of a terminal information storage unit according to the second embodiment;

FIGS. 9A and 9B are diagrams illustrating a first example of an editing process;

FIGS. 10A and 10B are diagrams illustrating a second example of the editing process;

FIGS. 11A and 11B are diagrams illustrating a third example of the editing process;

FIG. 12 is a flowchart illustrating the flow of information processing performed by the information processing system according to the second embodiment; and

FIG. 13 is a diagram illustrating an example of a hardware configuration of a computer that implements functions of the information processing apparatus.

### DETAILED DESCRIPTION OF THE PREFERRED EMBODIMENTS

Modes (hereinafter, referred to as “embodiments”) for carrying out an information processing apparatus, an information processing method, and a non-transitory computer readable storage medium having stored therein an information processing program according to the disclosed technology will be described in detail below with reference to the drawings. The information processing apparatus, the information processing method, and the non-transitory computer readable storage medium having stored therein an information processing program are not limited by the embodiments. In each of the embodiments below, the same components will be denoted by the same reference numerals and symbols, and description thereof will be omitted.

### First Embodiment

1. Information Processing

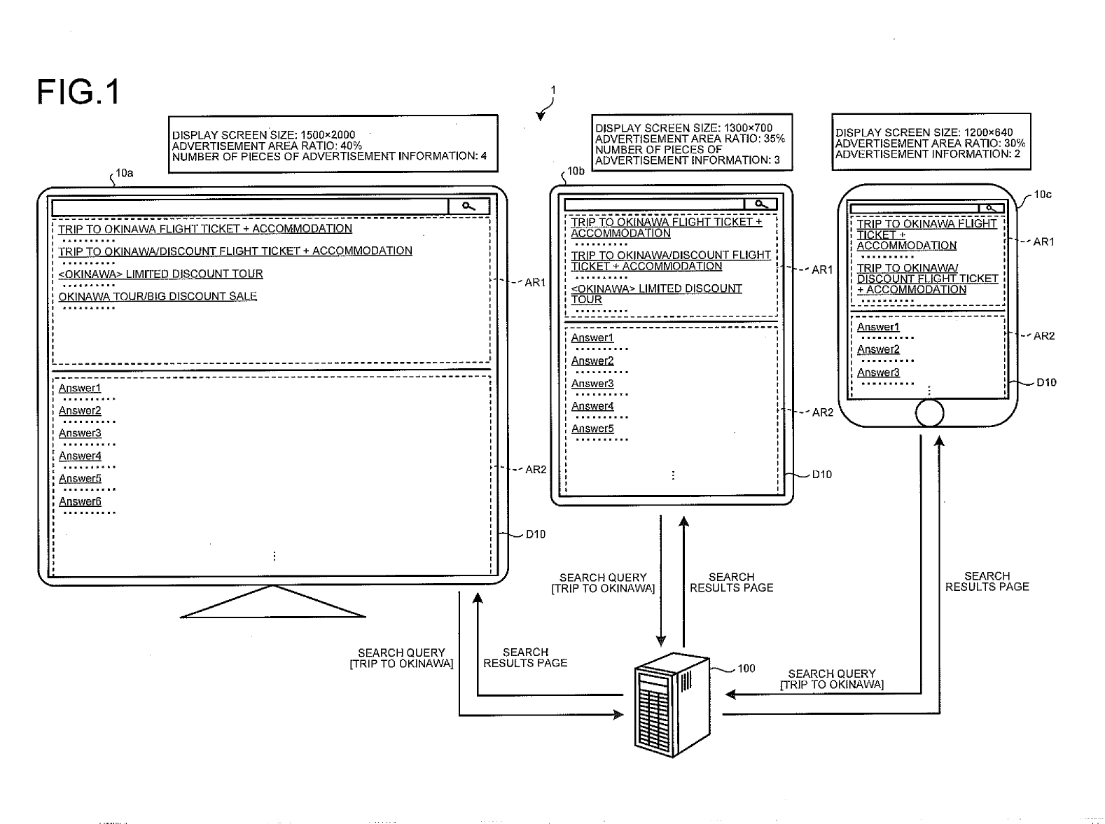

First, an example of information processing according to a first embodiment will be described with reference to FIG. 1. FIG. 1 is a diagram illustrating an example of the information processing according to the first embodiment. In the example in FIG. 1, an information processing system 1 includes a terminal device 10a, a terminal device 10b, a terminal device 10c, and an information processing apparatus 100. The terminal device 10a, the terminal device 10b, the terminal device 10c, and the information processing apparatus 100 are communicably connected to one another by wire or wireless via a network.

The terminal device 10a, the terminal device 10b, and the terminal device 10c are devices used by users. In the example in FIG. 1, it is assumed that the terminal device 10a is a desktop personal computer (PC), the terminal device 10b is a tablet terminal, and the terminal device 10c is a mobile phone. In the embodiments below, the terminal devices may be simply described as terminal devices 10 when they are not distinguished from one another. For example, the terminal device 10 displays a search results page corresponding to a search query that is input by a user through a predetermined search site.

The information processing apparatus 100 distributes, to the terminal device 10, a search results page including search results and advertisement information corresponding to a search query accepted from the terminal device 10. That is, in the embodiment, it is assumed that the advertisement information is an advertisement for search advertising.

It is determined in advance that, in the search results page, an advertisement area enclosing the advertisement information is equal to or smaller than a predetermined ratio relative to a display screen size of the terminal device 10 that has transmitted the search query.

The advertisement area according to the embodiment will be described in detail below. If the size of the advertisement area (hereinafter, may be described as an “advertisement area size”) is increased relative to the display screen size of the terminal device 10 used by a user, the user is likely to avoid clicking on the advertisement information. This is because, for example, primary search results for the search query may be interrupted by the advertisement information and may not be fully visible, and therefore the user may get a negative impression from the advertisement information. In other words, if the size of the advertisement area is equal to or smaller than a predetermined ratio relative to the display screen size, the advertisement information does not give a negative impression to the user and is not less likely to be clicked.

As described above, the possibility for the user to click on the advertisement information tends to depend on the ratio of the advertisement area size to the display screen size of the terminal device 10. In the embodiment, the ratio of the advertisement area size corresponding to the display screen size is determined based on the above--described characteristics of the user. That is, with respect to the display screen size, the ratio of the advertisement area size corresponding to the display screen size is determined based on an advertisement area size for which the user accepts to do a click.

In the embodiment, the display screen size and the advertisement area size are described as an area of a display screen D10; however, for example, a vertical size (vertical width) or a horizontal size (horizontal width) may be used. In FIG. 1, an example is illustrated in which, in the terminal device 10a with a display screen size “1500×2000 pixels”, the advertisement area size relative to the display screen size is set to “equal to or smaller than 40%” in advance. That is, in the terminal device 10a with the display screen size “1500×2000 pixels”, if the size of the advertisement area relative to the display screen size is “equal to or smaller than 40%”, advertisement information displayed in the advertisement area is not less likely to be clicked.

Furthermore, in this example, in the terminal device 10b with a display screen size “1300×700 pixels”, the advertisement area size relative to the display screen size is set to “equal to or smaller than 35%” in advance. Moreover, in this example, in the terminal device 10c with a display screen size “1200×640 pixels”, the advertisement area size relative to the display screen size is set to “equal to or smaller than 30%” in advance.

Next, the number of pieces of advertisement information will be described. As the number of pieces of advertisement information, a certain number of pieces of advertisement information is set that can be displayed in the advertisement area with a size equal to or smaller than a ratio that is determined in accordance with the display screen size. Furthermore, the number may be determined by taking into account the number based on, for example, wishful thinking, such as “want to display a certain number of pieces of advertisement information in an advertisement area with a certain size”, of an administrator or the like of the information processing apparatus 100.

In FIG. 1, an example is illustrated in which, in the terminal device 10a, “four pieces” of advertisement information can be displayed in an advertisement area AR1 with a size “equal to or smaller than 40%” of the display screen size “1500×2000 pixels”. Furthermore, an example is illustrated in which, in the terminal device 10b, “three pieces” of advertisement information can be displayed in the advertisement area AR1 with a size “equal to or smaller than 35%” of the display screen size “1300×700 pixels”. Moreover, an example is illustrated in which, in the terminal device 10c, “two pieces” of advertisement information can be displayed in the advertisement area AR1 with a size “equal to or smaller than 30%” of the display screen size “1200×640 pixels”.

The flow of a process performed by the information processing system 1 according to the first embodiment will be described in detail below. It is assumed that a user of each of the terminal devices 10a to 10c inputs a search query “trip to Okinawa” in a predetermined search site (described as a Y site). In response to the input, the terminal devices 10a to 10c transmit, as a request for a search results page corresponding to the search query “trip to Okinawa”, the search query “trip to Okinawa” to the information processing apparatus 100.

The information processing apparatus 100, upon accepting the search query “trip to Okinawa”, specifies a ratio of the advertisement area size determined relative to the display screen size of the terminal device 10 that has transmitted the search query, and specifies the number of pieces of advertisement information to be displayed in the advertisement area.

In the example in FIG. 1, the information processing apparatus 100 specifies that “four pieces of advertisement information are displayed such that the advertisement area size is equal to or smaller than 40% of the display area size”, with respect to the terminal device 10a. Furthermore, the information processing apparatus 100 specifies that “three pieces of advertisement information are displayed such that the advertisement area size is equal to or smaller than 35% of the display area size”, with respect to the terminal device 10b. Moreover, the information processing apparatus 100 specifies that “two pieces of advertisement information are displayed such that the advertisement area size is equal to or smaller than 30% of the display area size”, with respect to the terminal device 10c.

Subsequently, the information processing apparatus 100 acquires the specified number of pieces of advertisement information as distribution targets corresponding to the search query. For example, the information processing apparatus 100 determines the specified number of pieces of advertisement information as distribution targets and the order of display of the pieces of the advertisement information from among pieces of advertisement information for which the search query “trip to Okinawa” is set, on the basis of a bid unit price set for each piece of the advertisement information, an advertisement evaluation value calculated from a distribution record of each piece of the advertisement information, or the like, and acquires the pieces of the determined advertisement information as the distribution targets from a predetermined storage unit. Furthermore, the information processing apparatus 100 acquires search results corresponding to the search query from a predetermined storage unit.

In the example in FIG. 1, the information processing apparatus 100 acquires “four pieces” of advertisement information as distribution targets corresponding to the search query “trip to Okinawa” with respect to the terminal device 10a, acquires “three pieces” of advertisement information with respect to the terminal device 10b, and acquires “two pieces” of advertisement information with respect to the terminal device 10c.

Subsequently, the information processing apparatus 100 generates a search results page. Specifically, the information processing apparatus 100 generates the search results page by arranging the pieces of the acquired advertisement information as the distribution targets and the search results in the search results page. The information processing apparatus 100 distributes the generated search results page to the terminal device 10.

As illustrated in FIG. 1, in the terminal device 10a, the size of the advertisement area AR1 enclosing the “four pieces” of advertisement information is “equal to or smaller than 40%” of the display size “1500×2000 pixels”. Furthermore, in the terminal device 10b, the size of the advertisement area AR1 enclosing the “three pieces” of advertisement information is “equal to or smaller than 35%” of the display size “1300×700 pixels”. Moreover, in the terminal device 10c, the size of the advertisement area AR1 enclosing the “two pieces” of advertisement information is “equal to or smaller than 30%” of the display size “1200×640 pixels”.

As described above, upon accepting a search query, the information processing apparatus 100 acquires a certain number of pieces of advertisement information as distribution targets that can be displayed in an advertisement area with a size equal to or smaller than a ratio that is determined in accordance with the display screen size of the terminal device 10 that has transmitted the search query. Then, the information processing apparatus 100 distributes, to the terminal device 10, a search results page in which the pieces of the acquired advertisement information and search results are arranged. Thus, the information processing apparatus 100 can provide the advertisement information in the advertisement area with a certain size that does not give a negative impression to a user in accordance with the display screen size of the terminal device 10 that has transmitted the search query. Consequently, it is possible to prevent a reduction in the click rate.

2. Information Processing System

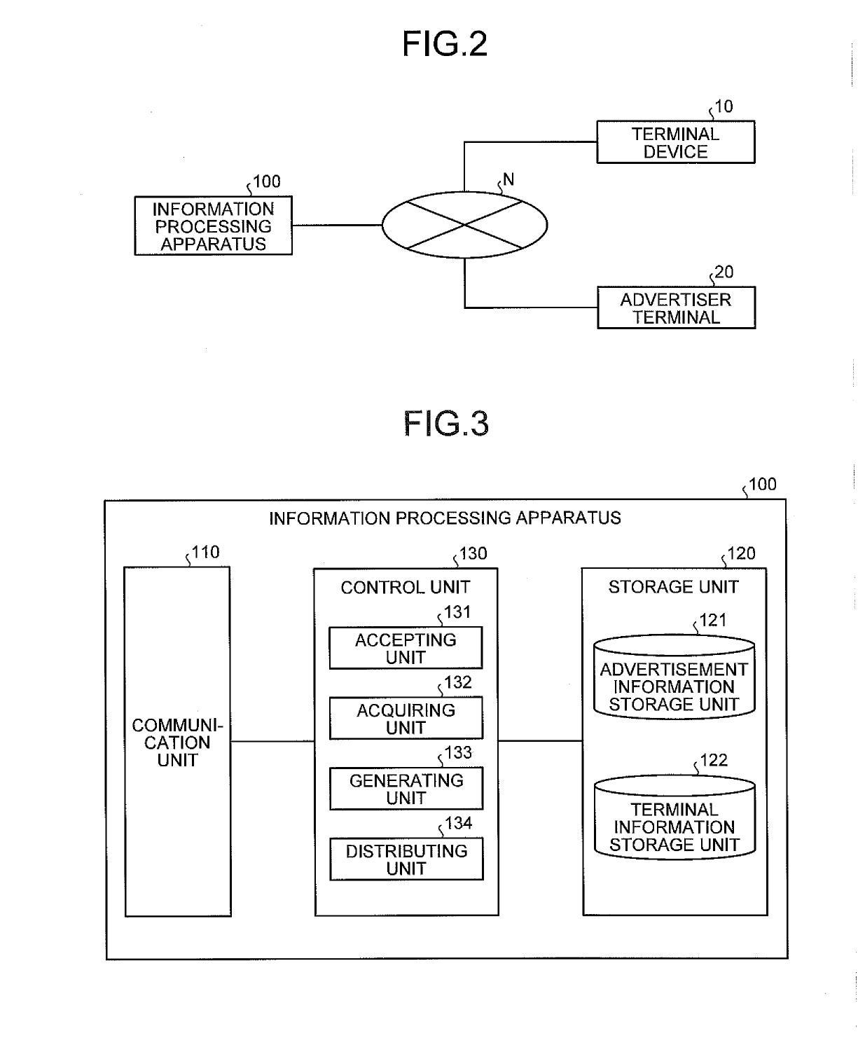

A configuration of the information processing system according to the first embodiment will be described below with reference to FIG. 2. FIG. 2 is a diagram illustrating a configuration example of the information processing system 1 according to the first embodiment. As illustrated in FIG. 2, the information processing system 1 includes the terminal device 10, an advertiser terminal 20, and the information processing apparatus 100. The terminal device 10, the advertiser terminal 20, and the information processing apparatus 100 are communicably connected to one another by wire or wireless via a network N. The information processing system 1 illustrated in FIG. 2 may include a plurality of the terminal devices 10, a plurality of the advertiser terminals 20, and a plurality of the information processing apparatuses 100.

The terminal device 10 is a device used by a user. For example, the terminal device 10 is a desktop PC, a notebook PC, a tablet terminal, a mobile phone, a personal digital assistant (PDA), or the like. When the user inputs a search query, the terminal device 10 transmits a page request for a search results page corresponding to the search query to the information processing apparatus 100. Furthermore, the terminal device 10 displays the search results page received from the information processing apparatus 100.

The advertiser terminal 20 is a device used by an advertiser. For example, the advertiser terminal 20 is a desktop PC, a notebook PC, a tablet terminal, a mobile phone, a PDA, or the like. The advertiser terminal 20 submits advertisement information to the information processing apparatus 100 in accordance with operation performed by the advertiser. For example, the advertiser terminal 20 submits, as the advertisement information, text data, in which a title, a uniform resource locator (URL), detailed descriptive text, and the like are described, to the information processing apparatus 100.

The information processing apparatus 100 distributes, to the terminal device 10, a search results page including search results and advertisement information corresponding to the search query accepted from the terminal device 10. Specifically, the information processing apparatus 100 distributes a search results page, in which a certain number of pieces of advertisement information are arranged such that the advertisement area size is equal to or smaller than a predetermined ratio relative to the display screen size of the terminal device 10.

3. Configuration of information processing apparatus The information processing apparatus 100 according to the embodiment will be described below with reference to FIG. 3. FIG. 3 is a diagram illustrating a configuration example of the information processing apparatus 100 according to the first embodiment. As illustrated in FIG. 3, the information processing apparatus 100 includes a communication unit 110, a storage unit 120, and a control unit 130.

The communication unit 110 is implemented by, for example, a network interface card (NIC) or the like. The communication unit 110 is connected to the network N by wire or wireless, and performs transmission and reception of information with the terminal device 10 and the advertiser terminal 20.

The storage unit 120 is implemented by, for example, a semiconductor memory device, such as a random access memory (RAM) or a flash memory, or a storage device, such as a hard disk or an optical disk. The storage unit 120 includes an advertisement information storage unit 121 and a terminal information storage unit 122.

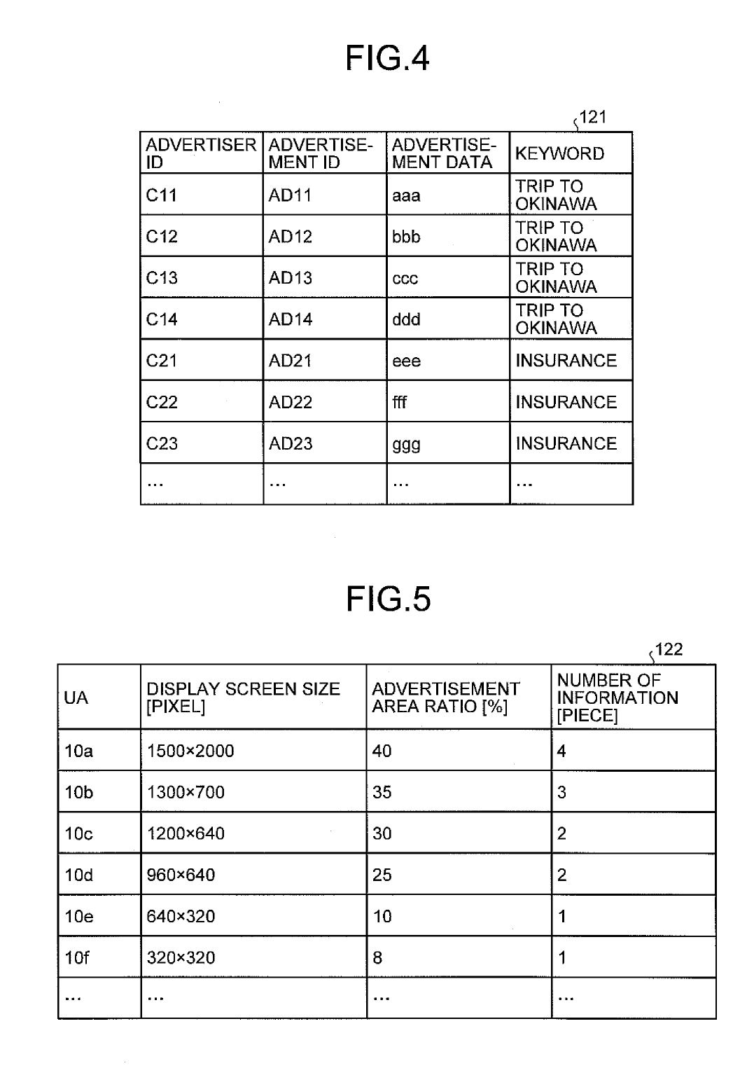

The advertisement information storage unit 121 is a storage unit that stores therein various types of information related to the advertisement information accepted from the advertiser terminal 20. FIG. 4 illustrates an example of the advertisement information storage unit 121 according to the first embodiment. In the example in FIG. 4, the advertisement information storage unit 121 includes items of an advertiser ID, an advertisement ID, advertisement data, and a keyword.

The advertiser ID is identification information for identifying the advertiser or the advertiser terminal 20. The advertisement ID is identification information for identifying the advertisement information. The advertisement data is data related to the advertisement information displayed on the search results page. In the example in FIG. 4, the advertisement data is represented by a conceptual symbol; however, in practice, the advertisement data is text data or the like, in which a title, a URL, detailed descriptive text, and the like are described. In this case, the title, the URL, and the detailed descriptive text are collectively regarded as a single piece of advertisement information. If a user selects (clicks) a title portion in the advertisement information, for example, the search results page is changed to a website run by the advertiser who has submitted the advertisement information.

The keyword is information for specifying advertisement information corresponding to the search query accepted from the terminal device 10, and is set by the advertiser. For example, the information processing apparatus 100 extracts, as a candidate distribution target, advertisement information associated with a keyword that matches the accepted search query. The information processing apparatus 100 may accept a targeting condition (age, gender, residence, or the like of the user) from the advertiser, in addition to the keyword.

Specifically, in FIG. 4, an example is illustrated in which an advertiser identified by an advertiser ID “C11” submits data “aaa” of advertisement information identified by an advertisement ID “AD11” and sets a keyword “trip to Okinawa”.

Referring back to FIG. 3, the terminal information storage unit 122 is a storage unit that stores therein various types of information related to the terminal device 10 used by a user. FIG. 5 illustrates an example of the terminal information storage unit 122 according to the first embodiment. In the example illustrated in FIG. 5, the terminal information storage unit 122 includes items of a user agent (hereinafter, may be described as a “UA”), a display screen size, an advertisement area ratio, and the number of pieces of advertisement information.

The “user agent” is identification information for identifying a type of the terminal device 10. For example, the terminal device 10 transmits the user agent together with the search query to the information processing apparatus 100. In the following, the terminal device 10 may be distinguished by using the UA. For example, the terminal device 10 of a type identified by a UA “10a” may be described as the terminal device 10a.

The “display screen size” is a size of the display screen D10 of the terminal device 10. In the embodiment, the display screen D10 represents the entire display screen. Furthermore, in the embodiment, it is assumed that the display screen size is an area; however, a vertical size or a horizontal size may be used.

The “advertisement area ratio” is a ratio of the advertisement area size to the display screen size of the terminal device 10, and is determined for each display screen size of the terminal device 10 in advance. For example, the possibility for the user to click the advertisement information tends to depend on the ratio of the advertisement area size to the display screen size of the terminal device 10. Therefore, a ratio of the advertisement area size, for which the user may accept to do a click, relative to the display screen size is determined as the “advertisement area ratio” on the basis of the above-described characteristics of the user.

The “number of pieces of advertisement information” indicates the number of pieces of advertisement information arranged in the advertisement area. As the “number of pieces of advertisement information”, a certain number of pieces of advertisement information is set that can be displayed in the advertisement area with a size equal to or smaller than a ratio that is determined in accordance with the display screen size as illustrated in FIG. 5.

Specifically, in FIG. 5, it is indicated that the display screen size of the terminal device 10a of a type identified by the UA “10a” is “1500×2000 pixels”. Furthermore, in this example, the ratio of the advertisement area size to the display screen size is set to “equal to or smaller than 40%” in advance for the display screen size “1500×2000 pixels”. Moreover, in this example, “four” is set as the number of pieces of advertisement information that can be displayed in the advertisement area with the size “equal to or smaller than 40%” of the display screen size “1500×2000 pixels”.

Referring back to FIG. 3, the control unit 130 is implemented by, for example, executing various programs stored in an internal storage device of the information processing apparatus 100 by a central processing unit (CPU), a micro processing unit (MPU), or the like using a RAM as a work area. For example, the various programs correspond to an application program called a web browser. Furthermore, the control unit 130 is implemented by, for example, an integrated circuit, such as an application specific integrated circuit (ASIC) or a field programmable gate array (FPGA).

As illustrated in FIG. 3, the control unit 130 includes an accepting unit 131, an acquiring unit 132, a generating unit 133, and a distributing unit 134, and implements or executes functions and operations of information processing as described below. The internal configuration of the control unit 130 is not limited to the configuration illustrated in FIG. 3, and any other configuration that performs the information processing as described below is applicable. Furthermore, a connection relation between the processing units of the control unit 130 is not limited to the connection relation illustrated in FIG. 3, and any other connection relation is applicable.

The accepting unit 131 accepts, when a user inputs a search query in a predetermined search site, a page request as a request for a search results page corresponding to the input search query from the terminal device 10. Furthermore, the accepting unit 131 accepts the UA of the terminal device 10 that has transmitted the search query, together with the page request.

The acquiring unit 132 acquires, from the advertisement information storage unit 121, a certain number of pieces of advertisement information that can be displayed in the advertisement area with a size equal to or smaller than a ratio that is determined in accordance with the display screen size.

An acquisition process performed by the acquiring unit 132 will be described below by using the terminal device 10c illustrated in FIG. 1. It is assumed that the user inputs a search query “trip to Okinawa” in a predetermined search site by using the terminal device 10c of a type identified by a UA “10c”. The terminal device 10c transmits the search query “trip to Okinawa” and the UA “10c” to the information processing apparatus 100.

The accepting unit 131 accepts the UA “10c” from the terminal device 10c, and accordingly, the acquiring unit 132 refers to the terminal information storage unit 122 by using the UA “10c”. The acquiring unit 132 specifies that “two pieces” of advertisement information can be displayed in the advertisement area AR1 with a size “equal to or smaller than 30%” of the display screen size “1200×640” of the terminal device 10c.

The acquiring unit 132 acquires “two pieces” of advertisement information as distribution targets from the advertisement information storage unit 121 because the number of pieces of advertisement information for the terminal device 10c is specified as “two”. For example, the acquiring unit 132 determines “two pieces” of advertisement information as distribution targets and the order of display of the pieces of the advertisement information from among pieces of advertisement information for which the keyword “trip to Okinawa” is set in the advertisement information storage unit 121, on the basis of a bid unit price or an advertisement evaluation value set for each piece of the advertisement information. Then, the acquiring unit 132 acquires, from the advertisement information storage unit 121, data of each piece of the determined advertisement information as distribution targets.

Furthermore, the acquiring unit 132 acquires search results corresponding to the search query “trip to Okinawa” from a predetermined storage unit. The generating unit 133 generates a search results page by arranging the data of the advertisement information and data of the search results acquired by the acquiring unit 132 in the search results page.

The distributing unit 134 distributes, to the terminal device 10 (in this example, the terminal device 10c), the search results page in which the advertisement information and the search results are arranged. Consequently, the search results page is displayed on the terminal device 10c. For example, as illustrated in FIG. 1, the terminal device 10c displays search results such that “two pieces” of advertisement information are arranged above a search results area AR2 in which the search results are arranged. In this case, the size of the advertisement area AR1 (for example, a rectangular advertisement area) enclosing the “two pieces” of advertisement information is equal to or smaller than “30%” of the display screen size “1200×640” of the terminal device 10c.

4. Flow of Information Processing

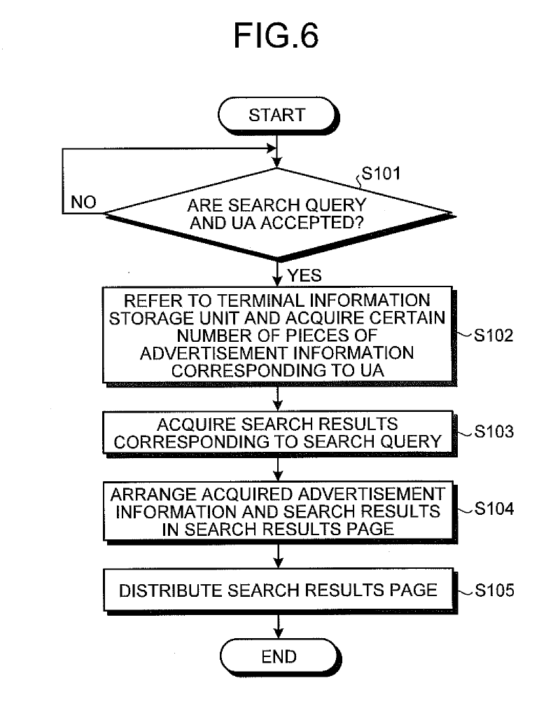

The flow of the information processing performed by the information processing system 1 according to the first embodiment will be described below with reference to FIG. 6. FIG. 6 is a flowchart illustrating the flow of the information processing performed by the information processing system I according to the first embodiment.

As illustrated in FIG. 6, the accepting unit 131 of the information processing apparatus 100 determines whether a search query and a UA are accepted from the terminal device 10 (Step S101). When determining that the search query and the UA are not accepted (NO at Step S101), the accepting unit 131 waits until the search query and the UA are accepted. In contrast, when determining that the search query and the UA are accepted (YES at Step S101), the accepting unit 131 sends the process to the acquiring unit 132.

When the accepting unit 131 accepts the search query and the UA, the acquiring unit 132 acquires, from the advertisement information storage unit 121, a certain number of pieces of advertisement information that can be displayed in an advertisement area with a size equal to or smaller than a ratio that is determined in accordance with the display screen size (Step S102). Specifically, the acquiring unit 132 refers to the terminal information storage unit 122 and specifies the number of pieces of advertisement information corresponding to the accepted UA. Then, the acquiring unit 132 acquires, from the advertisement information storage unit 121, data of the specified number of pieces of advertisement information as distribution targets corresponding to the search query. In this case, for example, the acquiring unit 132 determines the pieces of the advertisement information as distribution targets and the order of display of the pieces of the advertisement information on the basis of a bid unit price or an advertisement evaluation value of each piece of the advertisement information.

Furthermore, the acquiring unit 132 acquires, from a predetermined storage unit, data of search results corresponding to the search query accepted by the accepting unit 131 (Step S103). The processes at Step S102 and 5103 may be performed in reverse order or may be performed simultaneously.

The generating unit 133 arranges, in a search results page, the pieces of the advertisement information as distribution targets and the search results acquired by the acquiring unit 132 (Step S104). The distributing unit 134 distributes the search results page, in which the pieces of the advertisement information and the search results are arranged, to the terminal device 10 (Step S105).

### Second Embodiment

An information processing apparatus 200 according to a second embodiment edits advertisement information as a distribution target such that the advertisement area size is equal to or smaller than a ratio that is determined in accordance with the display screen size. This will be described below.

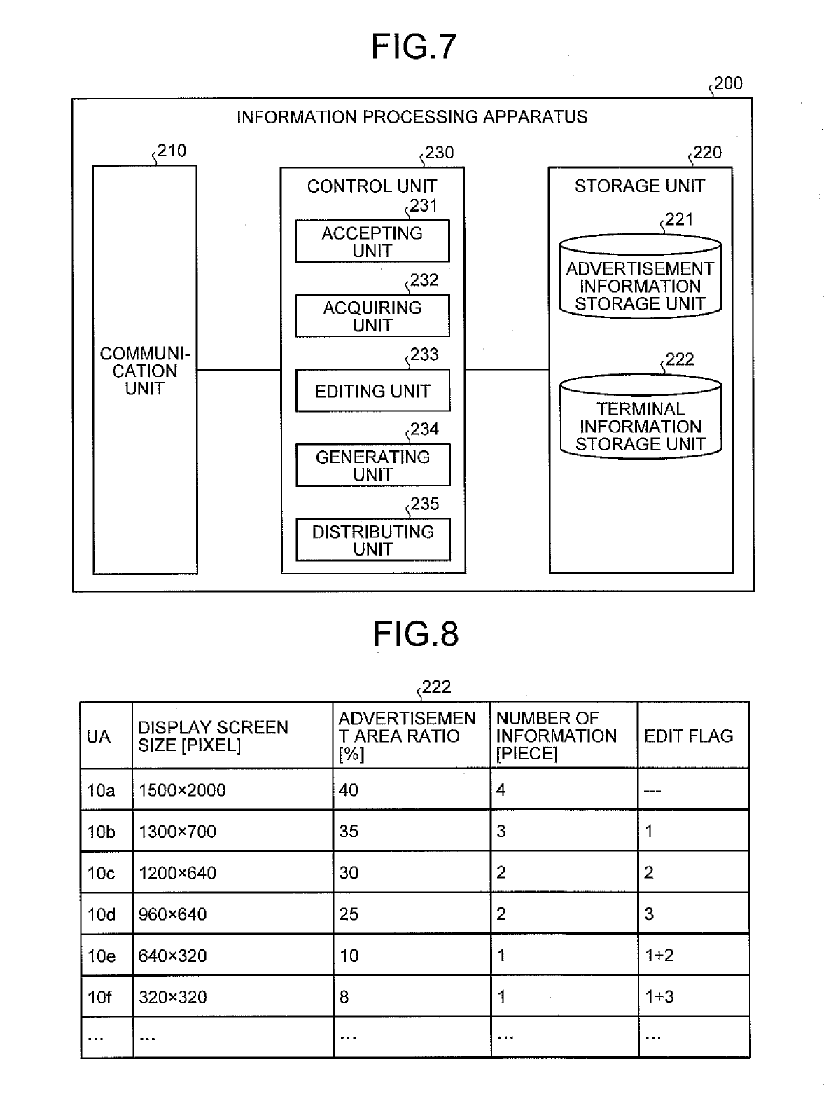

1. Configuration of information processing apparatus First, a configuration of the information processing apparatus 200 according to the second embodiment will be described with reference to FIG. 7. FIG. 7 is a diagram illustrating the configuration of the information processing apparatus 200 according to the second embodiment. As illustrated in FIG. 7, the information processing apparatus 200 includes a communication unit 210, a storage unit 220, and a control unit 230.

The communication unit 210 is implemented by, for example, a NIC or the like. The communication unit 210 is connected to the network N by wire or wireless, and performs transmission and reception of information with the terminal device 10 and the advertiser terminal 20.

The storage unit 220 is implemented by, for example, a semiconductor memory device, such as a RAM or a flash memory, or a storage device, such as a hard disk or an optical disk. The storage unit 220 includes an advertisement information storage unit 221 and a terminal information storage unit 222.

The advertisement information storage unit 221 is a storage unit corresponding to the advertisement information storage unit 121, and therefore, detailed explanation thereof will be omitted.

The terminal information storage unit 222 is a storage unit corresponding to the terminal information storage unit 122. FIG. 8 is a diagram illustrating an example of the terminal information storage unit 222 according to the second embodiment. As illustrated in FIG. 8, the terminal information storage unit 222 is a storage unit that further includes an item of an edit flag, in addition to the items included in the terminal information storage unit 122. The “edit flag” indicates information for specifying an editing process to be applied to data of the advertisement information as a distribution target acquired by an acquiring unit 232 from among predetermined editing processes. An editing unit 233 to be described later performs the editing process specified by the edit flag on the data of the advertisement information. For example, if the UA of the terminal device 10 that has transmitted the search query is “10b”, the editing unit 233 performs an editing process specified by an edit flag “1” on the data of the advertisement information. The data of the advertisement information is text data of a title or detailed descriptive text as described above.

In the first embodiment, it is described that a certain number of pieces of advertisement information that can be displayed in the advertisement area with a size equal to or smaller than a ratio that is determined in accordance with the display screen size is set as the number of pieces of advertisement information. However, it is found by experience that, when a certain number of pieces of advertisement information corresponding to a certain display screen size are displayed in a predetermined text size, the ratio of the advertisement area size to the display screen size is likely to exceed the corresponding ratio depending on the display screen size. Therefore, the edit flag is set to give an instruction to edit the data of the advertisement information such that the ratio of the advertisement area size to the display screen size is surely equal to or smaller than a corresponding ratio.

In the embodiment, it is assumed that the editing process specified by the edit flag “1” is to “edit the number of paragraphs of advertisement information”, an editing process specified by an edit flag “2” is to “edit the number of characters of advertisement information”, and an editing process specified by an edit flag “3” is to “edit a character size of advertisement information”. The three editing processes described here are examples, and other editing processes are also applicable. For example, if a single piece of advertisement information includes a title, a URL, and detailed descriptive text, it may be possible to apply an editing process to completely delete the detailed descriptive text.

Referring back to FIG. 7, the control unit 230 includes an accepting unit 231, the acquiring unit 232, the editing unit 233, a generating unit 234, and a distributing unit 235, and implements or executes functions and operations of information processing as described below. The internal configuration of the control unit 230 is not limited to the configuration illustrated in FIG. 7, and any other configuration that performs the information processing as described below is applicable. Furthermore, a connection relation between the processing units of the control unit 230 is not limited to the connection relation illustrated in FIG. 7, and any other connection relation is applicable.

In the information processing apparatus 200 according to the second embodiment, the accepting unit 231, the acquiring unit 232, the generating unit 234, and the distributing unit 235 correspond to the accepting unit 131, the acquiring unit 132, the generating unit 133, and the distributing unit 134 of the information processing apparatus 100, respectively.

The editing unit 233 will be described below. The editing unit 233 performs the editing process specified by the edit flag on the data of the advertisement information as described above such that the ratio of the size of the advertisement area to the display screen size is equal to or smaller than a ratio that is determined in accordance with the display screen size. The process performed by the editing unit 233 will be described below.

It is assumed that the accepting unit 231 accepts a search query “trip to Okinawa” and a UA “10b” from the terminal device 10b. Accordingly, the acquiring unit 232 refers to the terminal information storage unit 222, specifies the number of pieces of advertisement information as “three”, and acquires three pieces of advertisement information as distribution targets from the advertisement information storage unit 221. The acquiring unit 232 sends data of the pieces of the acquired advertisement information to the editing unit 233 because the edit flag “1” is associated with the UA “10b”.

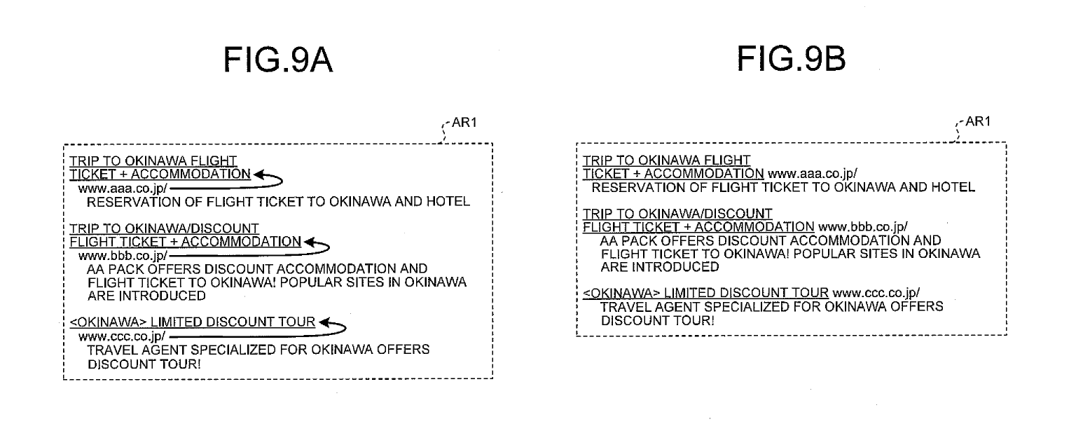

The editing unit 233 confirms that a process to “edit the number of paragraphs of advertisement information” is to be performed because the edit flag “1” is acquired from the acquiring unit 232, and performs the editing process on the data of the pieces of the advertisement information accepted from the acquiring unit 232. FIGS. 9A and 9B are diagrams illustrating a first example of the editing process.

As illustrated in FIG. 9A, in the embodiment, it is assumed that a single piece of advertisement information is configured with text data including a “title”, a “URL”, and “detailed descriptive text”. It is also assumed that each piece of advertisement information is stored in the advertisement information storage unit 221 such that the “title”, the “URL”, and the “detailed descriptive text” are arranged in this order in a layout as illustrated in FIG. 9A.

The editing unit 233 edits the number of paragraphs in the layout illustrated in FIG. 9A on the basis of the edit flag “1”. Specifically, the editing unit 233 performs the editing process of moving the URL to the side of the title in each piece of the advertisement information in order to reduce the number of paragraphs. Consequently, the editing unit 233 reduces the vertical size of the advertisement area AR1 including the three pieces of the advertisement information such that the ratio of the advertisement area size to the display screen size “1300×700” is equal to or smaller than “35%”.

In FIG. 9B, illustrates a state after the editing unit 233 has edited the paragraphs, where the vertical size of the advertisement area AR1 is reduced because the number of paragraphs is reduced as compared to the unedited state as illustrated in FIG. 9A. Consequently, the ratio of the advertisement area size to the display screen size “1300×700” can be “35% or smaller”.

The generating unit 234 arranges the data of the pieces of the advertisement information edited by the editing unit 233 in a search results page, and arranges search results corresponding to the search query “trip to Okinawa” acquired by the acquiring unit 232 in the search results page. The distributing unit 235 distributes, to the terminal device 10b, the search results page in which the pieces of the advertisement information and the search results are arranged.

In FIGS. 9A and 9B, an example is illustrated in which the editing unit 233 moves the URL. However, for example, the editing unit 233 may move the detailed descriptive text to reduce the number of paragraphs. Furthermore, the editing unit 233 may move both of the URL and the detailed descriptive text to reduce the number of paragraphs.

Furthermore, in FIGS. 9A and 9B, an example is illustrated in which the editing unit 233 performs the same process of moving the URL on each of the three pieces of advertisement information as distribution targets. However, for example, the editing unit 233 may perform the process on a predetermined piece of advertisement information among the pieces of the advertisement information as distribution targets. For another example, the editing unit 233 may perform a process of moving the URL for the first piece of the advertisement information from the top in FIGS. 9A and 9B, moving the detailed descriptive text for the second piece of the advertisement information, and moving both of the URL and the detailed descriptive text for the third piece of the advertisement information. However, in this process, the layout is different for each piece of the advertisement information, and the advertiser may feel an antipathy. Therefore, if a plurality of pieces of advertisement information as distribution targets are present, it is preferable to perform a uniform process on all pieces of the advertisement information.

The edit flag “2” will be described below. It is assumed that the accepting unit 231 accepts a search query “trip to Okinawa” and the UA “10c” from the terminal device 10. Accordingly, the acquiring unit 232 refers to the terminal information storage unit 222, specifies the number of pieces of advertisement information as “two”, and acquires two pieces of advertisement information as distribution targets from the advertisement information storage unit 221. The acquiring unit 232 sends data of the pieces of the acquired advertisement information to the editing unit 233 because the edit flag “2” is associated with the UA “10c”.

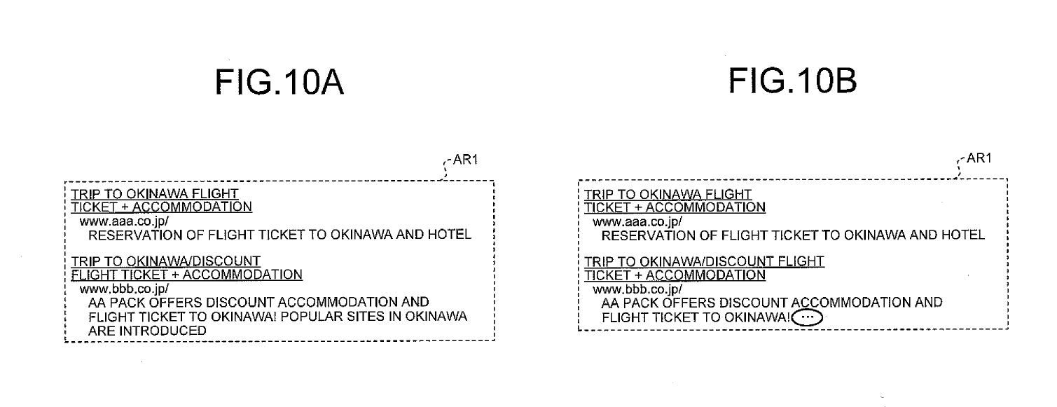

The editing unit 233 edits the number of characters of the pieces of the advertisement information as distribution targets with respect to a predetermined layout on the basis of the edit flag “2”. FIGS. 10A and 10B are diagrams illustrating a second example of the editing process. As illustrated in FIGS. 10A and 10B, the editing unit 233 edits the detailed descriptive text of each piece of the advertisement information into an abbreviated form in order to reduce the number of characters. Specifically, as illustrated in FIG. 10B, the editing unit 233 separates the detailed descriptive text by a predetermined punctuation and replace the subsequent text with “. . . ” as abbreviation. Consequently, the editing unit 233 reduces the vertical size of the advertisement area AR1 enclosing the two pieces of the advertisement information such that the ratio of the advertisement area size to the display screen size “1200×640” is equal to or smaller than “30%”.

In FIG. 10B, illustrates a state after the editing unit 233 has edited the number of characters, where the vertical size of the advertisement area AR1 is reduced because the number of characters is reduced as compared to the unedited state as illustrated in FIG. 10A. Consequently, the ratio of the advertisement area size to the display screen size “1200×640” can be “35%” or smaller.

The generating unit 234 arranges the data of the pieces of the advertisement information edited by the editing unit 233 in a search results page, and arranges search results corresponding to the search query “trip to Okinawa” acquired by the acquiring unit 232 in the search results page. The distributing unit 235 distributes, to the terminal device 10c, the search results page in which the pieces of the advertisement information and the search results are arranged.

While an example has been described in which the detailed descriptive text is replaced with “. . . ” as abbreviation, the editing unit 233 may reduce the number of characters by, for example, deleting the text after the predetermined punctuation instead of the replacement. Furthermore, the editing unit 233 may perform the process of reducing the number of characters on detailed descriptive text with paragraphs equal to or greater than a predetermined number or detailed descriptive text with characters equal to or greater than a predetermined number, with respect to detailed descriptive texts before editing. Moreover, the editing unit 233 may perform the above-described editing process on an object (for example, the URL) other than the detailed descriptive text. Furthermore, if a plurality of pieces of advertisement information as distribution targets are present, the editing unit 233 may perform the above-described editing process on all pieces of the advertisement information or on a predetermined piece of the advertisement information.

However, if the above-described abbreviation process is performed on a predetermined piece of advertisement information among pieces of advertisement information, a corresponding advertiser may feel an antipathy. Therefore, if a plurality of pieces of advertisement information as distribution targets are present, it is preferable to uniformly perform the abbreviation process on all pieces of the advertisement information. Furthermore, it is preferable to notify the advertiser in advance that the text, such as a title or detailed descriptive text, may be abbreviated depending on the size of the advertisement area.

The edit flag “3” will be described below. It is assumed that the accepting unit 231 accepts a search query “trip to Okinawa” and a UA “10d” from the terminal device 10d. Accordingly, the acquiring unit 232 refers to the terminal information storage unit 222, specifies the number of pieces of advertisement information as “two”, and acquires two pieces of advertisement information as distribution targets from the advertisement information storage unit 221. The acquiring unit 232 sends data of the pieces of the acquired advertisement information to the editing unit 233 because the edit flag “3” is associated with the UA “10d”.

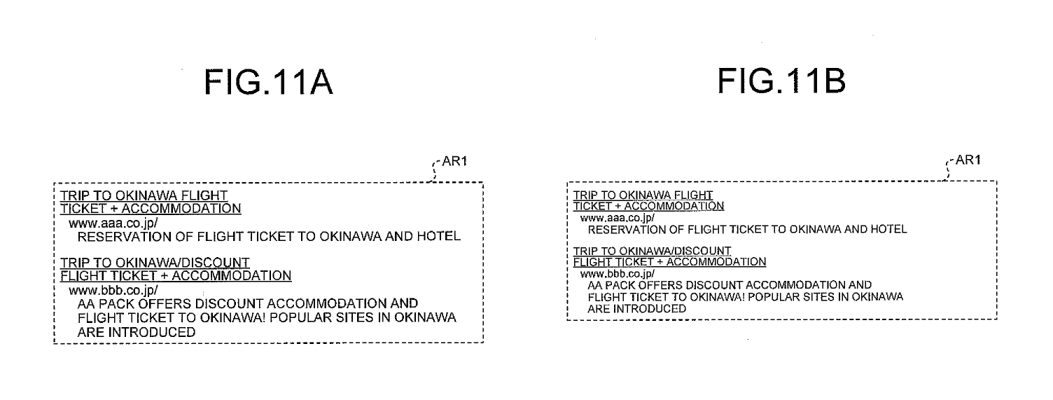

The editing unit 233 edits the character size of the pieces of the advertisement information as distribution targets with respect to a predetermined layout on the basis of the edit flag “3”. FIGS. 11A and 11B are diagrams illustrating a third example of the editing process. As illustrated in FIGS. 11A and 11B, the editing unit 233 uniformly reduces the character size in each piece of the advertisement information. Consequently, the editing unit 233 reduces the vertical size of the advertisement area AR1 enclosing the two pieces of the advertisement information such that the ratio of the advertisement area size to a display screen size “960×640” is equal to or smaller than “25%”.

In FIG. 11B, illustrates a state after the editing unit 233 has edited the character size, where the vertical size of the advertisement area AR1 is reduced because the character size is reduced as compared to the unedited state as illustrated in FIG. 11A. Consequently, the ratio of the advertisement area size to the display screen size “960 x 640” can be “25%” or smaller.

The generating unit 234 arranges the data of the pieces of the advertisement information edited by the editing unit 233 in a search results page, and arranges search results corresponding to the search query “trip to Okinawa” acquired by the acquiring unit 232 in the search results page. The distributing unit 235 distributes, to the terminal device 10d, the search results page in which the pieces of the advertisement information and the search results are arranged.

The editing unit 233 may set the character size to equal to or greater than a predetermined size. For example, the editing unit 233 may set the character size to equal to or greater than a display size that can be recognized by a normal user.

The editing unit 233 may extract a top portion of a title or detailed descriptive text with a character size equal to or greater than the predetermined size that can be displayed in the advertisement area AR1 from advertisement information including the text, and generate advertisement information formed of the extracted top portion of the text. The advertisement information is not limited to the above-described example, and the editing unit 233 may generate advertisement information such that a top portion of text in the advertisement information is initially displayed in the advertisement area AR1 and the text is displayed in the form of a stream with time. For example, the editing unit 233 may generate advertisement information such that text is displayed so as to be stream from the right to the left in the advertisement area AR1.

While an example has been described in which the character size is uniformly reduced for the pieces of the advertisement information as distribution targets. However, for example, the editing unit 233 may reduce text of each data to a different size such that the character size of the title is reduced by one point and the character size of each of the URL and the detailed descriptive text is reduced by two points. Furthermore, the editing unit 233 may reduce the size to a different size for each piece of the advertisement information. Moreover, if a plurality of pieces of advertisement information as distribution targets are present, the editing unit 233 may perform the above-described editing process on all pieces of the advertisement information or on a predetermined piece of the advertisement information.

An example has been described in which the editing unit 233 performs a single predetermined editing process on a predetermined display screen size. However, the editing unit 233 may apply the multiple editing processes as described above on the advertisement information as a distribution target. For example, in FIG. 8, an edit flag “1+2” is associated with a terminal device 10e, and an edit flag “1+3” is associated with a terminal device 10f.

Specifically, when accepting a search query from the terminal device 10 with a UA “10e”, the editing unit 233 performs both of a process to “edit the number of paragraphs of advertisement information” specified by the edit flag 1 and a process to “edit the number of characters of advertisement information” specified by the edit flag 2 on the advertisement information as a distribution target.

Furthermore, when accepting a search query from the terminal device 10 with a UA “10f”, the editing unit 233 performs both of a process to “edit the number of paragraphs of advertisement information” specified by the edit flag 1 and a process to “edit the character size of advertisement information” specified by the edit flag 3 on the advertisement information as a distribution target.

While the three editing processes have been described above, it is possible to arbitrarily set an editing process to be performed on a certain display screen size by the editing unit 233. For example, in the example in FIG. 8, the display screen size corresponding to the UA “10b” is associated with the edit flag “1”, but it is not limited thereto, and may be associated with the edit flag “2”. The same applies to the other UAs.

Furthermore, an example has been described in which the editing unit 233 reduces the vertical size of the advertisement area AR1 in accordance with the editing process. In this case, it may be possible to set the shortest vertical size of the vertical size of the advertisement area AR1 so as to prevent the editing unit 233 from reducing the size to below the shortest vertical size. Moreover, the editing unit 233 may reduce the horizontal size instead of the vertical size of the advertisement area AR1, or may reduce both of the vertical size and the horizontal size. It may be possible to set the shortest horizontal size in addition to the shortest vertical size.

2. Flow of Information Processing

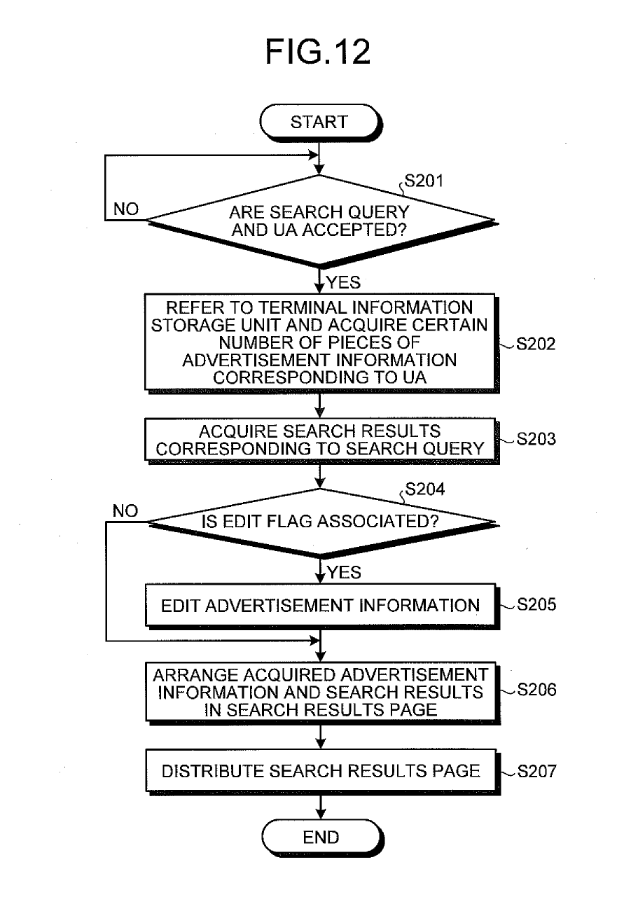

The flow of the information processing performed by the information processing system 2 according to the second embodiment will be described below with reference to FIG. 12. FIG. 12 is a flowchart illustrating the flow of the information processing performed by the information processing system 2 according to the second embodiment.

As illustrated in FIG. 12, the accepting unit 231 of the information processing apparatus 200 determines whether a search query and a UA are accepted from the terminal device 10 (Step S201). When determining that the search query and the UA are not accepted (NO at Step S201), the accepting unit 231 waits until the search query and the UA are accepted. In contrast, when determining that the search query and the UA are accepted (YES at Step S201), the accepting unit 231 sends the process to the acquiring unit 232.

When the accepting unit 231 accepts the search query and the UA, the acquiring unit 232 acquires, from the advertisement information storage unit 221, a certain number of pieces of advertisement information that can be displayed in an advertisement area with a size equal to or smaller than a ratio that is determined in accordance with the display screen size (Step S202). Specifically, the acquiring unit 232 refers to the terminal information storage unit 222 and specifies the number of pieces of advertisement information corresponding to the accepted UA. Then, the acquiring unit 232 acquires, from the advertisement information storage unit 221, the specified number of pieces of advertisement information as distribution targets corresponding to the search query. In this case, for example, the acquiring unit 232 determines the pieces of the advertisement information as distribution targets and the order of display of the pieces of the advertisement information on the basis of a bid unit price or an advertisement evaluation value of each piece of the advertisement information.

Furthermore, the acquiring unit 232 acquires, from a predetermined storage unit, data of search results corresponding to the search query accepted by the accepting unit 231 (Step S203). The processes at Step S202 and 5203 may be performed in reverse order or may be performed simultaneously.

If the edit flag is associated with a display screen size corresponding to the UA accepted by the receiving unit 231 (YES at Step S204), the acquiring unit 232 sends data of the pieces of the acquired advertisement information and the edit flag to the editing unit 233, and shifts to a process (Step S205) performed by the editing unit 233. In contrast, if the edit flag is not associated (NO at Step S204), the acquiring unit 232 sends the data of the pieces of the acquired advertisement information and the data of the search results to the generating unit 234, and shifts to a process (Step S206) performed by the generating unit 234.

When accepting the data of the pieces of the advertisement information and the edit flag from the acquiring unit 232, the editing unit 233 performs the editing process specified by the edit flag on the data of the pieces of the accepted advertisement information (Step S205). Then, the editing unit 233 sends the data of the pieces of the edited advertisement information to the generating unit 234.

The generating unit 234 generates a search results page by arranging the pieces of the data acquired from each of the units in the search results page (Step S206). The distributing unit 235 distributes the search results page, in which the pieces of the advertisement information and the search results are arranged, to the terminal device 10 (Step S207).

### Other Embodiments

The above-described first and second embodiments may be embodied in various different forms other than the above-described embodiments. Other embodiments will be described below.

1. Dynamic Determination of Advertisement Area Ratio

In the above-described first and second embodiments, an example has been described in which the ratio of the advertisement area size corresponding to the display screen size is determined in advance for each display screen size of the terminal device 10 and stored in the terminal information storage unit 122. In the example, the acquiring unit 132 refers to the terminal information storage unit 122 and acquires a certain number of pieces of advertisement information that can be displayed in an advertisement area with a size equal to or smaller than a ratio that is determined relative to the display screen size of the terminal device 10 that has transmitted the search query.

However, the ratio of the advertisement area size to the display screen size need not always be determined and stored in the terminal information storage unit 122 in advance. In this case, the information processing apparatus 100 and the information processing apparatus 200 dynamically determine the ratio of the advertisement area size to the display screen size of the terminal device 10 that has transmitted a search query every time the search query is accepted. This will be described below by using the information processing apparatus 100.

For example, it is assumed that the information processing apparatus 100 stores therein an index value indicating a relation between the display screen size of the terminal device 10 and the ratio of the advertisement area size to the display screen size. As one example, the information processing apparatus 100 stores therein an index value indicating that the ratio of the advertisement area size increases with an increase in the display screen size. The accepting unit 131 of the information processing apparatus 100 performs, as a determining unit, a process of dynamically determining the ratio of the advertisement area size to the display screen size of the terminal device 10 that has transmitted the search query, on the basis of the index value. As one example, when accepting a search query, the accepting unit 131 refers to the terminal information storage unit 122 and specifies a display screen size corresponding to the UA of the terminal device 10 that has transmitted the search query. Then, the accepting unit 131 determines the ratio of the advertisement area size to the specified display screen size on the basis of the index value.

2. Form of Advertisement

In the first and second embodiments, an example has been described in which the advertisement information is a search advertisement. However, the advertisement information may be a display advertisement (banner advertisement). This will be described below by using the second embodiment.

The advertisement information storage unit 221 stores therein data (image data or the like) related to a display advertisement accepted from an advertiser. Furthermore, in the terminal information storage unit 222, the advertisement area ratio indicates a ratio of an advertisement area size, in which the display advertisement is displayed, relative to each display screen size. Similarly to the case of the search advertisement, for example, a ratio of the advertisement area size, for which a user may accept to do a click, relative to each display screen size is set as the advertisement area ratio. Furthermore, in the case of the display advertisement, the number of pieces of advertisement information need not be set.

If the advertisement information is the display advertisement, the accepting unit 231 accepts a page request for a predetermined web page and the UA from the terminal device 10. When the accepting unit 231 accepts the page request and the UA, the acquiring unit 232 acquires advertisement information as a distribution target from the advertisement information storage unit 221, and specifies an advertisement area ratio corresponding to the accepted UA by referring to the terminal information storage unit 222. Furthermore, if the edit flag is associated with the display screen size corresponding to the accepted UA, the acquiring unit 232 sends data of the acquired advertisement information and the edit flag to the editing unit 233.

The editing unit 233 performs the editing process specified by the edit flag on the data of the advertisement information accepted from the acquiring unit 232, and sends the data of the edited advertisement information to the generating unit 234. The generating unit 234 generates a web page by arranging the data of the accepted advertisement information in an advertisement area of the web page corresponding to the page request accepted from the terminal device 10.

In the web page, an advertisement area with a predetermined size is already set, which is different from the search advertisement. Therefore, the generating unit 234 adjusts the size of the advertisement area such that the ratio of the size of the advertisement area to the display screen size of the terminal device 10 that has transmitted the page request is equal to or smaller than the ratio specified by the acquiring unit 232, and arranges the data of the accepted advertisement information. Furthermore, the generating unit 234 may adjust a layout of the web page through the adjustment of the advertisement area.

The distributing unit 235 distributes the web page generated by the generating unit 234 to the terminal device 10.

While an example has been described in which the generating unit 234 generates a web page by adjusting the advertisement area size or the layout of the web page, the process related to generation of the web page may be performed by the terminal device 10 that has transmitted the page request. This will be described below.

For example, the generating unit 234 generates control information (for example, JavaScript (registered trademark)) to instruct the terminal device 10 to perform adjustment such that the ratio of the advertisement area size of the web page to the display screen size of the terminal device 10 is equal to or smaller than the ratio specified by the acquiring unit 232, and to adjust the layout of the web page. The generating unit 234 may embed, in the control information, the display screen size of the terminal device 10 that has transmitted the page request or may cause the terminal device 10 to acquire the display screen size.

The distributing unit 235 distributes the web page corresponding to the page request and the control information generated by the generating unit 234 to the terminal device 10. The terminal device 10 generates a web page based on the control information accepted from the information processing apparatus 200, and displays the generated web page.

3. Ratio of Advertisement Area

In the above-described first and second embodiments, an example has been described in which the ratio of the advertisement area size corresponding to the display screen size of the terminal device 10 is determined. However, the ratio of the advertisement area size may be constant independent of the display screen size. As the number of pieces of advertisement information, the number of pieces of advertisement information that can be displayed in an advertisement area with a size based on the ratio is set.

4. System Configuration

Each of the units of the information processing apparatuses 100 and 200 according to the above-described embodiments may be configured by devices different from the information processing apparatuses 100 and 200. For example, a device different from the information processing apparatuses 100 and 200 may include the advertisement information storage units 121 and 221.

5. Program

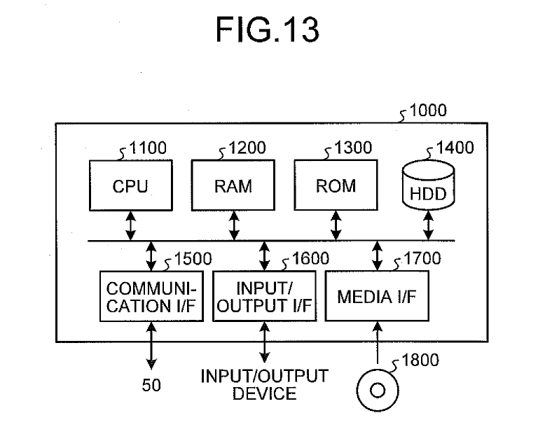

The information processing apparatuses 100 and 200 according to the above-described embodiments are implemented by, for example, a computer 1000 with a configuration as illustrated in FIG. 13. In the following, a description will be given by using the information processing apparatus 100 as an example. FIG. 13 is a diagram illustrating an example of a hardware configuration of the computer 1000 that implements the functions of the information processing apparatus 100. The computer 1000 includes a CPU 1100, a RAM 1200, a ROM 1300, an HDD 1400, a communication interface (I/F) 1500, an input/output I/F 1600, and a media I/F 1700.

The CPU 1100 operates based on a program stored in the ROM 1300 or the HDD 1400, and controls each of units. The ROM 1300 stores therein a boot program executed by the CPU 1100 when the computer 1000 is activated, a program that depends on the hardware of the computer 1000, and the like.

The HDD 1400 stores therein a program executed by the CPU 1100, data used by the program, and the like. The communication I/F 1500 receives data from other devices via a communication network 50, sends the data to the CPU 1100, and transmits data generated by the CPU 1100 to other devices via the communication network 50.

The CPU 1100 controls an output device, such as a display or a printer, and an input device, such as a keyboard or a mouse, via the input/output I/F 1600. The CPU 1100 acquires data from the input device via the input/output I/F 1600. The CPU 1100 outputs generated data to the output device via the input/output I/F 1600.

The media I/F 1700 reads a program or data stored in a recording medium 1800, and provides the program or the data to the CPU 1100 via the RAM 1200. The CPU 1100 loads the program onto the RAM 1200 from the recording medium 1800 via the media I/F 1700, and executes the loaded program. The recording medium 1800 may be, for example, an optical recording medium such as a digital versatile disk (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the information processing apparatus 100 according to the first embodiment, the CPU 1100 of the computer 1000 implements the functions of the control unit 130 by executing the program loaded on the RAM 1200. Furthermore, the HDD 1400 stores therein data stored in the storage unit 120. While the CPU 1100 of the computer 1000 reads the program from the recording medium 1800 and executes the program, the program may be acquired via the communication network 50 from other devices as another example.

For another example, when the computer 1000 functions as the information processing apparatus 200 according to the second embodiment, the CPU 1100 of the computer 1000 implements the functions of the control unit 230 by executing the program loaded on the RAM 1200.

6. Others

Of the processes described in the embodiment, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in the drawings are not limited to the information illustrated in the drawings.

The components of the apparatuses illustrated in the drawings are functionally conceptual and need not necessarily be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Furthermore, the embodiments described above may be combined appropriately as long as the processes do not conflict with each other.

7. Effects

As described above, the information processing apparatus 100 according to the first embodiment includes the accepting unit 131 and the distributing unit 134. The accepting unit 131 accepts a request for a web page from the terminal device 10. The distributing unit 134 distributes a web page including an advertisement area with a size equal to or smaller than a predetermined ratio of a display screen size of the terminal device 10.

Thus, the information processing apparatus 100 according to the first embodiment can prevent a reduction in the click rate for the advertisement information, so that it is possible to prevent a reduction in revenue from the advertisement.

Furthermore, the accepting unit 131 according to the first embodiment accepts, as the request for the web page, a search query input by a user from the terminal device. The distributing unit 134 distributes, as the web page, a search results page in which advertisement information corresponding to the search query is displayed in the advertisement area.

Thus, the information processing apparatus 100 according to the first embodiment can prevent a reduction in the click rate of the search advertisement.

Moreover, a determining unit (the accepting unit 131) according to the first embodiment determines a ratio of the size of the advertisement area to the display screen size on the basis of information on the terminal device 10. The distributing unit 134 distributes a web page including an advertisement area with a size equal to or smaller than the ratio determined by the determining unit (the accepting unit 131).

Thus, the information processing apparatus 100 according to the first embodiment can dynamically determine the ratio of the advertisement area size to the display screen size every time the search query or the page request is accepted. Consequently, it is possible to improve the accuracy for determination of the ratio.

Furthermore, the acquiring unit 132 according to the first embodiment acquires a certain number of pieces of advertisement information that can be displayed in the advertisement area. The distributing unit 134 distributes a web page in which the pieces of the advertisement information acquired by the acquiring unit 132 are displayed.

Thus, the information processing apparatus 100 according to the first embodiment can prevent the web page from giving a negative impression to the user.

Moreover, the distributing unit 134 according to the first embodiment distributes a web page including an advertisement area based on a ratio that is determined in accordance with the display screen size of the terminal device.

Thus, the information processing apparatus 100 according to the first embodiment can provide, for each display screen size, advertisement information in the advertisement area with an appropriate size corresponding to the display screen size, so that it is possible to prevent a reduction in the click rate.

Furthermore, the editing unit 233 according to the second embodiment edits advertisement information such that the advertisement area is equal to or smaller than a predetermined ratio. The distributing unit 235 distributes a web page in which the advertisement information edited by the editing unit 233 is displayed in the advertisement area.

Thus, the information processing apparatus 200 according to the second embodiment can set the ratio of the advertisement area size to the display screen size to equal to or smaller than the predetermined ratio with accuracy, so that it is possible to prevent a reduction in the click rate.

Moreover, the editing unit 233 according to the second embodiment sets a display size of text included in the advertisement information to equal to or greater than a predetermined size, and extracts a top portion of the text that can be displayed in the advertisement area in the display size. The distributing unit 235 distributes a web page in which advertisement information as the text extracted by the editing unit 233 is displayed in the advertisement area.

Thus, the information processing apparatus 200 according to the second embodiment can display the advertisement information in which the text is set to equal to or greater than a predetermined size. Consequently, for example, it is possible to prevent a situation in which a user using the terminal device 10 with a small display screen size is not able to easily recognize characters. That is, it is possible to prevent a situation in which the user's visibility of the advertisement information is reduced, regardless of the display screen size.

Furthermore, “a unit” recited in the claims may be replaced with “a section, a module, or a means” or “a circuit”. For example, the distributing unit may be replaced with a distributing means or a distributing circuit.

According to an embodiment, it is possible to prevent a reduction in the click rate for advertisement information.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an accepting unit that accepts a request for a web page from a terminal device; and
a distributing unit that distributes a web page including an advertisement area with a size equal to or smaller than a predetermined ratio of a display screen size of the terminal device.

2. The information processing apparatus according to claim 1, wherein
the accepting unit accepts, as the request for the web page, a search query input by a user from the terminal device, and
the distributing unit distributes, as the web page, a search results page in which advertisement information corresponding to the search query is displayed in the advertisement area.

3. The information processing apparatus according to claim 1, further comprising:
a determining unit that determines a ratio of a size of the advertisement area to the display screen size on the basis of information on the terminal device, wherein
the distributing unit distributes a web page including an advertisement area with a size equal to or smaller than the ratio determined by the determining unit.

4. The information processing apparatus according to claim 1, further comprising:
an acquiring unit that acquires a certain number of pieces of advertisement information that can be displayed in the advertisement area, wherein
the distributing unit distributes a web page in which the pieces of the advertisement information acquired by the acquiring unit are displayed.

5. The information processing apparatus according to claim 1, further comprising:
an editing unit that edits advertisement information such that the advertisement area is equal to or smaller than the predetermined ratio, wherein
the distributing unit distributes a web page in which the advertisement information edited by the editing unit is displayed in the advertisement area.

6. The information processing apparatus according to claim 1, wherein
the editing unit sets a display size of text included in the advertisement information to equal to or greater than a predetermined size, and extracts a top portion of the text that can be displayed in the advertisement area in the display size, and
the distributing unit distributes a web page in which advertisement information as the text extracted by the editing unit is displayed in the advertisement area.

7. The information processing apparatus according to claim 1, wherein the distributing unit distributes a web page including the advertisement area based on a ratio that is determined in accordance with the display screen size of the terminal device.

8. An information processing method implemented by a computer, comprising:
accepting a request for a web page from a terminal device; and
distributing a web page including an advertisement area with a size equal to or smaller than a predetermined ratio of a displays screen size of the terminal device.

9. A non-transitory computer readable storage medium having stored therein an information processing program causing a computer to execute a process comprising:
accepting a request for a web page from a terminal device; and
distributing a web page including an advertisement area with a size equal to or smaller than a predetermined ratio of a displays screen size of the terminal device.
